(19) United States
(12) Patent Application Publication
(10) Pub. No.: US 2025/0387981 A1
(43) Pub. Date: Dec. 25, 2025

(54) Plug

(71) Applicant: Illinois Tool Works Inc., Glenview, IL (US)

(72) Inventors: Jiahui He, Shanghai (CN); Zhilin Li, Shanghai (CN); Xiaojin Liu, Shanghai (CN)

(21) Appl. No.: 19/243,473

(22) Filed: Jun. 19, 2025

(30) Foreign Application Priority Data
Jun. 21, 2024 (CN) 202410813459.7
Jul. 19, 2024 (CN) 202410976846.2

(51) Int. Cl. B29C 65/48; B29C 65/56; B29C 65/72; B29L 31/30

(52) U.S. Cl. CPC B29C 65/4815; B29C 65/565; B29C 65/72; B29L 2031/3005

(57) ABSTRACT

The present disclosure provides a plug for covering a hole in a component, comprising a cover body, a support portion and a connecting member. The cover body has a thickness direction. The support portion is connected to a side of the cover body in the thickness direction and has a support portion central axis. The connecting member is connected to the support portion and comprises at least two engagement portions arranged around the support portion central axis. The connecting member has elasticity to enable the at least two engagement portions to move toward and away from the support portion central axis with elastic deformation of the connecting member. The plug in the present disclosure has a relatively small thickness.

### RELATED APPLICATIONS

The present application claims the benefit of Chinese Patent Application Nos. 202410813459.7, filed Jun. 21, 2024, and 202410976846.2, filed Jul. 19, 2024, each titled “Plug,” the contents of which are hereby incorporated by reference.

### TECHNICAL FIELD

The present disclosure relates to a plug, and in particular a plug for closing a hole in sheet metals of a vehicle.

### BACKGROUND

Holes are produced in sheet metals of vehicles during a machining process of the vehicles. When the machining process of the vehicles is completed, these holes are not required. In the later stage of the machining process of the vehicles, these holes need to be closed by using plugs to achieve the effect of waterproofing and dust-proofing. Generally, a plug is first inserted into a hole in a sheet metal, and then the plug is sealed with the sheet metal by means of a hot melt adhesive process.

### SUMMARY

The present disclosure relates generally to a plug, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a plug according to a first embodiment of the present disclosure.

FIG. 1B is a perspective view of the plug of FIG. 1A from another perspective.

FIG. 1C is a top view of the plug of FIG. 1A.

FIG. 1D is a bottom view of the plug of FIG. 1A.

FIG. 1E is a side view of the plug of FIG. 1A.

FIG. 2A is a cross-sectional view of the plug of FIG. 1D taken along a line A-A.

FIG. 2B is a cross-sectional perspective view of the plug of FIG. 2A.

FIG. 3A is an exploded schematic view of the plug of FIG. 1A and a mounting portion.

FIG. 3B is a perspective view of the plug partially inserted into the mounting portion.

FIG. 4A is a cross-sectional view of the plug of FIG. 1A mounted in the mounting portion in place.

FIG. 4B is a cross-sectional perspective view of the plug and the mounting portion of FIG. 3A.

FIG. 5A is a perspective view of a plug according to a second embodiment of the present disclosure.

FIG. 5B is a bottom view of the plug of FIG. 5A.

FIG. 5C is a top view of the plug of FIG. 5A.

FIG. 5D is a side view of the plug of FIG. 5A.

FIG. 6A is a cross-sectional view of the plug of FIG. 1D taken along a line B-B.

FIG. 6B is a cross-sectional perspective view of the plug of FIG. 6A.

FIG. 7 is a cross-sectional view of the plug of FIG. 5A mounted in a mounting portion in place.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a plug for covering a hole in a component, and the plug comprises a cover body, a support portion and a connecting member. The cover body has a thickness direction. The support portion is connected to a side of the cover body in the thickness direction and has a support portion central axis. The connecting member is connected to the support portion and comprises at least two engagement portions arranged around the support portion central axis. The connecting member has elasticity to enable the at least two engagement portions to move toward the support portion central axis with elastic deformation of the connecting member.

According to the plug as described above, the at least two engagement portions comprise at least two protrusions that are connected to an end of the connecting member away from the cover body and extend in a direction away from the support portion central axis, and the protrusions have a distance from the cover body.

According to the plug as described above, the connecting member extends in a direction substantially parallel to the cover body and has a distance from a circumferential edge of the cover body.

According to the plug as described above, a maximum distance from the engagement portions of the connecting member to the support portion central axis is greater than a maximum distance from an outer side of the support portion to the support portion central axis.

According to the plug as described above, the connecting member has at least two connecting arms that connect the engagement portions to the support portion.

According to the plug as described above, the support portion comprises a support block, and the at least two connecting arms comprise at least two first connecting arms and at least two second connecting arms. The at least two first connecting arms are connected in sequence, each of the engagement portions is arranged at a joint of adjacent first connecting arms, and the second connecting arms connect corresponding first connecting arms to the support block.

According to the plug as described above, each of the first connecting arms comprises a concave portion recessed toward the support block and located in the middle of the corresponding first connecting arm.

According to the plug as described above, a connection line connecting two ends of each of the second connecting arms is staggered from a central axis of the support block.

According to the plug as described above, a joint of the second connecting arm and the first connecting arm and a joint of the second connecting arm and the support block are respectively close to two adjacent concave portions in a circumferential direction, and the second connecting arm is bent toward the corresponding engagement portion.

According to the plug as described above, the support portion comprises at least two support blocks, and the at least two connecting arms comprise at least two pairs of connecting arms. Respective first ends of each of the pairs of connecting arms are connected to each other, respective second ends of each of the pairs of connecting arms are connected to the corresponding support blocks, and the engagement portion is arranged at a joint of the first ends of one of the pairs of connecting arms.

According to the plug as described above, each of the at least two pairs of connecting arms comprises a concave portion recessed toward the support portion central axis.

According to the plug as described above, a minimum distance from the concave portion to the central axis is less than a distance from the support block to the support portion central axis.

According to the plug as described above, the connecting member is arranged separately from the cover body, and the connecting member comprises an abutting portion that abuts against a surface of a second side of the cover body and is slidable relative to the cover body when subjected to a force in a direction toward or away from the support block.

According to the plug as described above, the abutting portion is arranged close to the engagement portions.

According to the plug as described above, positioning marks are provided on a side of the cover body away from the support block in the thickness direction, and each of the positioning marks is located between the adjacent engagement portions in a circumferential direction.

According to the plug as described above, a distance from a side of the connecting member away from the cover body to the second side of the cover body is not more than twice the thickness of the cover body.

According to the plug as described above, the plug further comprises a sealing portion connected to the cover body and close to the circumferential edge of the cover body. At least a portion of the sealing portion is located at a side of the cover body connected to the support block, and the sealing portion comprises a hot melt adhesive.

According to the plug as described above, the support portion has a side portion and the connecting member is connected to the side portion of the support portion. The connecting member overlaps at least a portion of the support portion in the thickness direction of the cover body.

The plug in the present disclosure has a cover body, a support portion and a connecting member. The connecting member can enter into a hole in the sheet metal, so that the plug is connected to the sheet metal. The support portion is connected to a side of the cover body, and the connecting member is connected to the support portion and extends in a direction substantially parallel to the cover body. The connecting member has elasticity and can be deformed in the direction toward the support portion central axis. The plug in the present disclosure has a relatively small thickness and can accommodate a small mounting space.

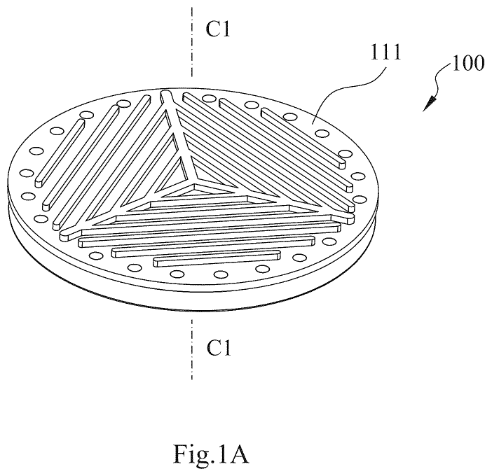

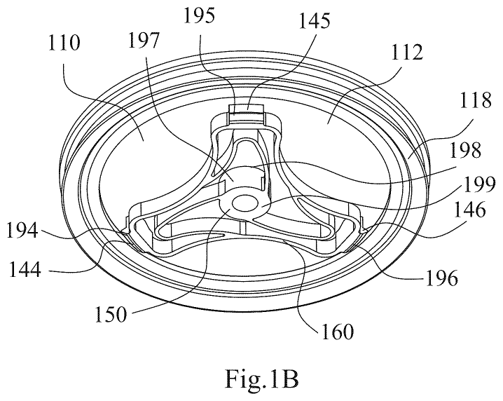

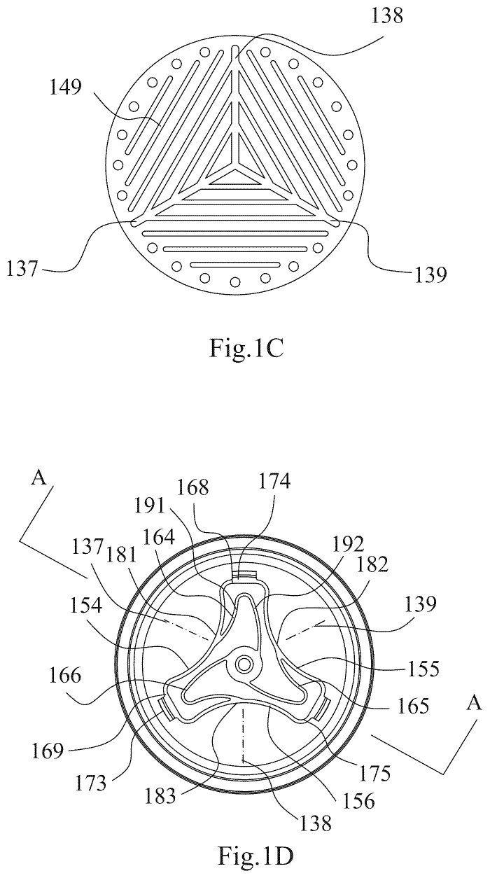

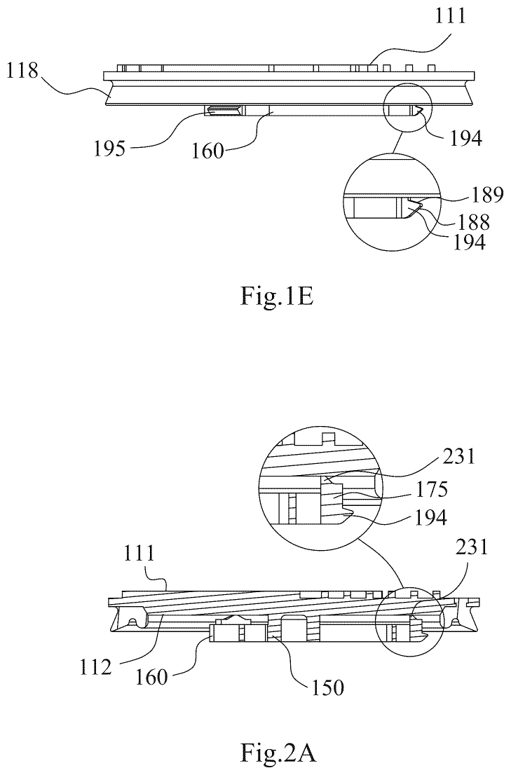

FIG. 1A is a perspective view of a plug according to a first embodiment of the present disclosure. FIG. 1B is a perspective view of the plug of FIG. 1A from another perspective, FIG. 1C is a top view of the plug of FIG. 1A, FIG. 1D is a bottom view of the plug of FIG. 1A, and FIG. 1E is a side view of the plug of FIG. 1A. FIGS. 1A-1E show the structure of the plug from different perspectives, among which FIGS. 1A and 1B are views seen from above and below perspectives, respectively.

As shown in FIGS. 1A-1E, the plug 100 includes a cover body 110, a support portion 150, a connecting member 160, and a sealing portion 118, and has an axial direction and a radial direction. The cover body 110 is substantially the shape of a circular plate. The cover body 110 has a first side 111 and a second side 112 which are arranged opposite to each other in the axial direction. The first side 111 and the second side 112 extend in the radial direction. The support portion 150 is connected to the second side 112 of the cover body 110 and extends in the axial direction. The support portion 150 has a support portion central axis C1. The central axis C1 passes through the center of the support portion 150 and extends in the axial direction of the plug 100. In one embodiment of the present disclosure, the support portion 150 is substantially a cylindrical support block. The support portion 150 has a proximal end 198 connected to the cover body 110 and a distal end 199 away from the cover body 110, and a side portion 197 located between the proximal end 198 and the distal end 199 and extending in a circumferential direction. The connecting member 160 is connected to the side portion 197 of the support portion 150 and extends in a direction substantially parallel to the cover body 110. The connecting member 160 includes three engagement portions 144, 145 and 146 on an outer side thereof. The engagement portions 144, 145 and 146 can cooperate with the cover body 110 to connect the plug to a corresponding portion. The dimension of the connecting member 160 in the radial direction is smaller than the dimension of the cover body 110 in the radial direction. In the axial direction of the plug 100, the plug 100 has a certain thickness. A thickness direction of the plug 100 is consistent with the axial direction of the plug 100.

In one embodiment of the present disclosure, the support portion central axis C1 passes through the center of the cover body 110. In another embodiment of the present disclosure, the support portion central axis C1 is staggered from the center of the cover body 110.

The sealing portion 118 is connected to the cover body 110 and extends in the thickness direction of the plug 100. The sealing portion 118 is close to a circumferential edge of the cover body 110. At least a portion of the sealing portion 118 is located on the second side 112 of the cover body 110. The sealing portion 118 is made of a hot melt adhesive, and the sealing portion 118 is connected to the cover body 110 by means of an overmolding process.

The connecting member 160 is arranged separately from the cover body 110 and can be deformed in the radial direction to reduce the size of the outer contour of the connecting member 160. The connecting member 160 includes first connecting arms 154, 155 and 156, and second connecting arms 164, 165 and 166. The first connecting arms 154, 155 and 156 are connected in sequence and arranged around the support portion 150. There is a distance between the first connecting arms 154, 155 and 156 and the support portion 150. The second connecting arms 164, 165 and 166 connect the first connecting arms 154, 155 and 156 to the support portion 150. Two ends of each of the second connecting arms 164, 165 and 166 are not on the same diameter of the cover body, that is, a connection line connecting the two ends of each of the second connecting arms 164, 165 and 166 is staggered from the central axis of the support portion 150.

The connecting member 160 has a plurality of engagement sections 173, 174 and 175, and the engagement sections 173, 174 and 175 are portions of the connecting member 160 that are further away from the support portion 150. The engagement sections 173, 174 and 175 are substantially on the same circumference. The engagement portions 144, 145, 146 are arranged at the engagement sections 173, 174 and 175, respectively.

The middle of each of the first connecting arms 154, 155 and 156 is recessed toward the support portion 150, so as to form concave portions 181, 182 and 183. The two ends of each of the first connecting arms 154, 155 and 156 are provided with bent sections 168 and 169 that are bent toward the direction of the support portion 150. Each of the engagement sections 173, 174 and 175 is formed by the connection of the bent section 168 or 169 of the respective first connecting arm 154, 155 and 156 with the bent section 168 or 169 of an adjacent connecting arm.

The first connecting arms 154, 155 and 156 have the same structure and are uniformly distributed in the circumferential direction.

Each of the second connecting arms 164, 165 and 166 includes a first section 191 and a second section 192. The first section 191 has one end connected to a concave portion of one of the first connecting arms and the other end connected to the second section 192, and the second section 192 has one end connected to the first section 191 and the other end connected to the support portion 150, and is close to the concave portion of an adjacent first connecting arm. Each of the second connecting arms 164, 165 and 166 protrudes toward a respective engagement section, and a joint of the first section 191 and the second section 192 is close to the respective engagement section. The first section 191 and the second section 192 are each substantially arc-shaped and are bent toward the same direction to facilitate deformation of the connecting member 160. For example, as shown in FIG. 1D, one end of the second section 192 of the second connecting arm 164 is connected to the support portion 150 and is close to the concave portion 182 of the first connecting arm 155, and the other end of the second section is connected to the first section 191. One end of the first section 191 is connected to the concave portion 181 of the first connecting arm 154, and the other end of the first section is connected to the second section 192. The first section 191 and the second section 192 of the second connecting arm 164 both extend toward the engagement section 174 and are connected to each other, i.e. the middle of the second connecting arm is bent toward the respective engagement section. The first section 191 and the second section 192 are substantially arc-shaped, which are both arched substantially in the direction of the first connecting arm 155 and bent toward the same direction.

The second connecting arms 164, 165 and 166 have the same structure and are uniformly distributed in the circumferential direction, and the plurality of second connecting arms substantially form a spiral shape.

The first side 111 of the cover body 110 has positioning marks 137, 138 and 139. The positioning marks 137, 138 and 139 are uniformly distributed in the circumferential direction and each substantially aligned in the radial direction with a middle portion of the respective first connecting arm 154, 155 and 156. That is, the positioning marks 137, 138 and 139 are each located substantially between two adjacent engagement portions. The dashed lines in FIG. 1D illustrate the relative positions of the positioning marks 137, 138 and 139. It should be understood that the positioning marks are not visible on the second side 112 of the cover body 110. In one embodiment of the present disclosure, the positioning marks 137, 138 and 139 are ribs protruding from the surface of the first side 111. In other embodiments of the present disclosure, the positioning marks may be any recognizable marks, including stereoscopic shapes or patterns.

Between the positioning marks 137, 138 and 139 of the first side 111 of the cover body 110, there is further included a plurality of ribs 149 for increasing friction of the first side 111 of the cover body 110. The ribs 149 may be of other shapes that can increase friction.

Engagement portions 144, 145 and 146 are protrusions 194, 195 and 196 extending from the engagement sections 173, 174 and 175 of the connecting member 160 in a direction away from the support portion 150. Each of the protrusions 194, 195, and 196 is close to the end of the respective engagement section 173, 174 and 175 away from the cover body 110, and thus has a distance from the cover body 110. The protrusions 194, 195 and 196 extend outwardly in the radial direction and are gradually smaller in thickness. The protrusions 194, 195 and 196 are of the same structure, and the shape of the protrusion 194 will be described below as an example. Referring to FIG. 1E, the protrusion 194 includes a guide face 188 and an engagement face 189. The guide face is further away from the cover body 110 than the engagement face 189. The guide face 188 extends obliquely in the radial direction toward the cover body 110 for guiding the protrusion 194 into a hole in a mounting portion. The engagement face 189 is arranged to face the cover body 110, and the engagement face 189 extends horizontally in the radial direction, or extends slightly obliquely in a direction away from the cover body 110. The engagement face 189 cooperates with the cover body 110 and the sealing portion 118, allowing the mounting portion to be located between the cover body 110 and the engagement face 189. Two sides of the mounting portion 301 are respectively contacted by the sealing portion 118 and the protrusion, and the plug 100 is not easily detached from the mounting portion.

When the protrusions 194, 195 and 196 of the connecting member 160 are subjected to external pressure, the connecting member 160 can be deformed such that the protrusions 194, 195 and 196 move toward the support portion 150, and the size of the outer contour of the connecting member 160 is reduced and can enter into a hole in a corresponding portion.

In other embodiments of the present disclosure, the shape of the cover body 110 may be of other shape that is not circular, which shape may be determined according to the shape of the hole in the mounting portion.

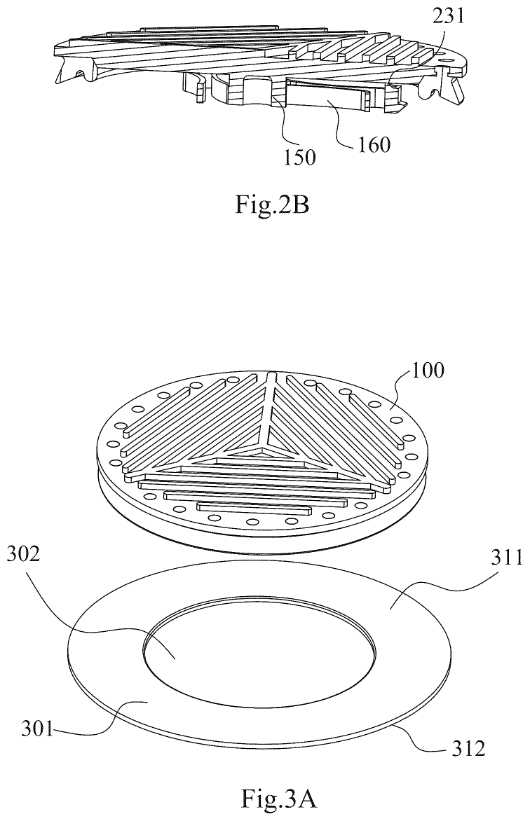

FIG. 2A is a cross-sectional view of the plug of FIG. 1D taken along a line A-A, and FIG. 2B is a cross-sectional perspective view of the plug of FIG. 2A.

As shown in FIGS. 2A and 2B, the connecting member 160 is arranged separately from the cover body 110, with a gap between the first and second connecting arms of the connecting member 160 and the cover body 110. The connecting member comprises an abutting portion 231. The abutting portion 231 is connected to the engagement section 175 and can abut against the second side 112 of the cover body 110. The abutting portion 231 prevents the connecting member 160 from moving toward the cover body 110 in the axial direction or reduces the distance by which the connecting member 160 moves toward the cover body 110 during entry of the connecting member 160 into the hole in the mounting portion.

In other embodiments of the present disclosure, the abutting portion is arranged at other positions on the connecting member 160. In another embodiment of the present disclosure, the connecting member 160 is in contact with the cover body 110, and it is not necessary to provide any additional abutting portion 231.

As shown in FIG. 2A, in the thickness direction of the plug, the connecting member 160 overlaps with at least a portion of the support portion 150. In one embodiment of the present disclosure, in the thickness direction of the plug, the connecting member 160 does not extend beyond the end of the support portion 150 away from the cover body 110.

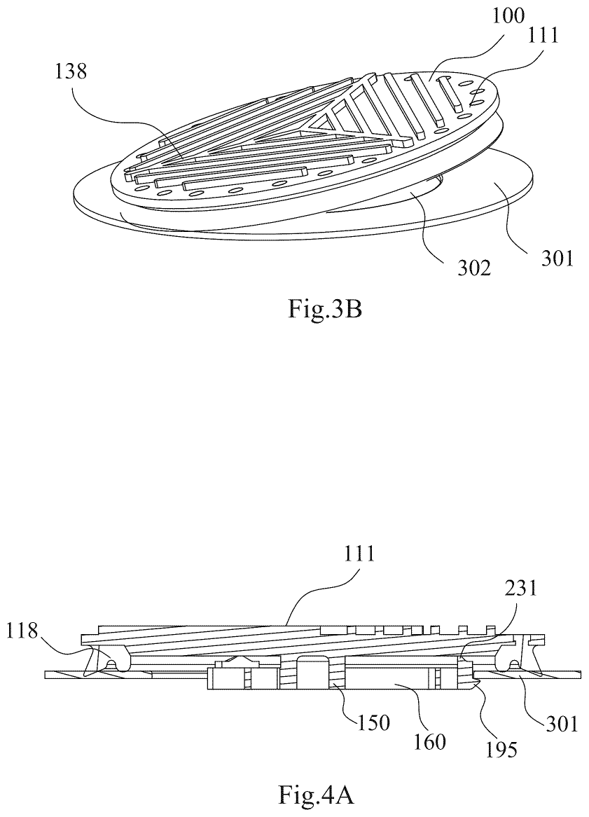

FIG. 3A is an exploded schematic view of the plug of FIG. 1A and the mounting portion, and FIG. 3B is a perspective view of the plug partially inserted into the mounting portion. As shown in FIGS. 3A and 3B, the mounting portion 301 is a thin plate and has a first surface 311 and a second surface 312 opposite to each other, and a hole 302 running through the first surface 311 and the second surface 312. The plug 100 can close the hole 302.

When the plug 100 is mounted into the mounting portion, the connecting member 160 of the connecting member 160 is aligned with the hole 302, a positioning mark is selected, such as the positioning mark 138, the plug 100 is tilted such that the positioning mark 138 is in the lowest position, and then part of the connecting member 160 is inserted into the hole 302. The protrusions 194 and 196, which are close to the positioning mark, pass through the hole 302, and the respective engagement faces 189 of the protrusions 194 and 196 abut against the second surface 312 of the mounting portion 301. In this case, the side of the cover body 110 away from the positioning mark 138 is higher than a surface of the mounting portion 301, and the higher side of the cover body 110 corresponds to the protrusion 195. The higher side of the cover body 110 is pressed such that the guide face 188 of the protrusion 195 abuts against an edge of the hole 302, continuing to press the side of the cover body 110 away from the positioning mark 138, the protrusion 195 is then pressed, and the connecting member 160 is thus deformed. During the deformation of the connecting member 160, the edges of the hole press the protrusions 194, 195 and 196 to move them toward the support portion 150, and the size of the outer contour of the connecting member 160 is reduced. In this way, the protrusion 195 can pass through the hole 302 and reach below the second surface 312.

When the connecting member 160 is deformed, the first connecting arms 154, 155 and 156 are bent toward their respective concave portions such that the protrusions 194, 195, and 196 can move toward the support portion 150.

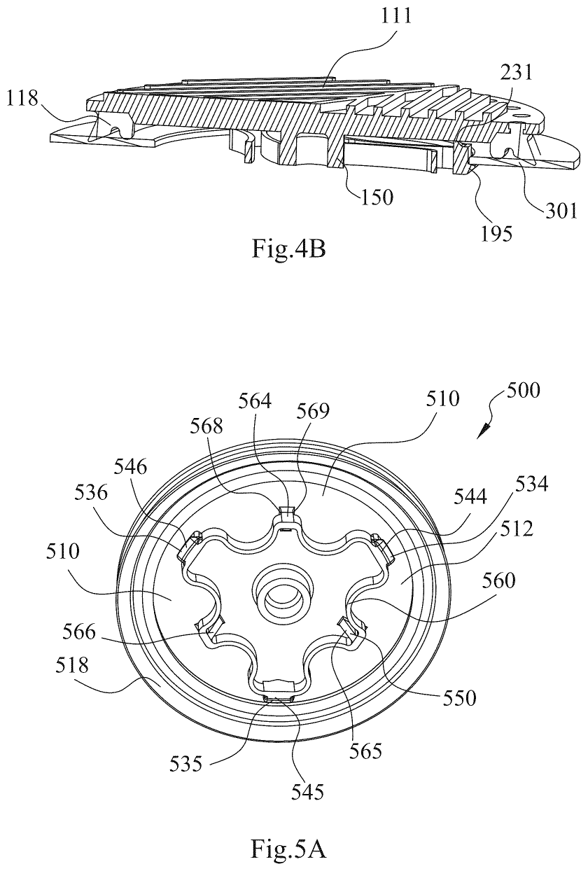

FIG. 4A is a cross-sectional view of the plug of FIG. 1A mounted in the mounting portion in place, and FIG. 4B is a cross-sectional perspective view of the plug and the mounting portion of FIG. 3A.

As shown in FIGS. 4A and 4B, when the plug 100 is mounted in the mounting portion 301 in place, the mounting portion is clamped between the sealing portion 118 of the cover body 110 and the protrusions 194, 195 and 196, and the plug 100 is connected to the mounting portion 301. The sealing portion 118 abuts against the first surface 311 of the mounting portion 301. In this case, the plug 100 is not easily movable relative to the mounting portion 301. The sealing portion 118 is heated by using a hot melt tool. After the hot melting and condensation process, the sealing portion 118 forms a seal with the first surface 311, thereby sealing and closing the hole 302 in the mounting portion 301.

The connecting member 160 of the plug in the present disclosure can be deformed in the radial direction, and the connecting member 160 has good elasticity and is easy to be mounted into the hole of the mounting portion 302. Moreover, the connecting member 160 may be set shorter in the axial direction. That is, the thickness of the connecting member 160 is relatively small, so that the overall thickness of the plug 100 is relatively small. In one embodiment of the present disclosure, the distance from the side of the connecting member 160 away from the cover body 110 to the second side of the cover body 110 is no more than 2 times the thickness of the cover body 110. In one embodiment of the present disclosure, the distance from the side of the connecting member 160 away from the cover body 110 to the second side of the cover body 110 is no more than 1.8 times the thickness of the cover body 110.

In an application of the present disclosure, the mounting portion 301 is sheet metal of a vehicle, and the hole 302 is a hole created during a machining process, and is required to be sealed after the machining process of the vehicle. The design of the vehicle is relatively compact, the mounting space of the plug 100 is small, and the plug 100 is required to have a relatively small thickness. The design of the connecting member 160 in the present disclosure enables the plug 100 to have a relatively small thickness and to be easily connected to the mounting portion 301.

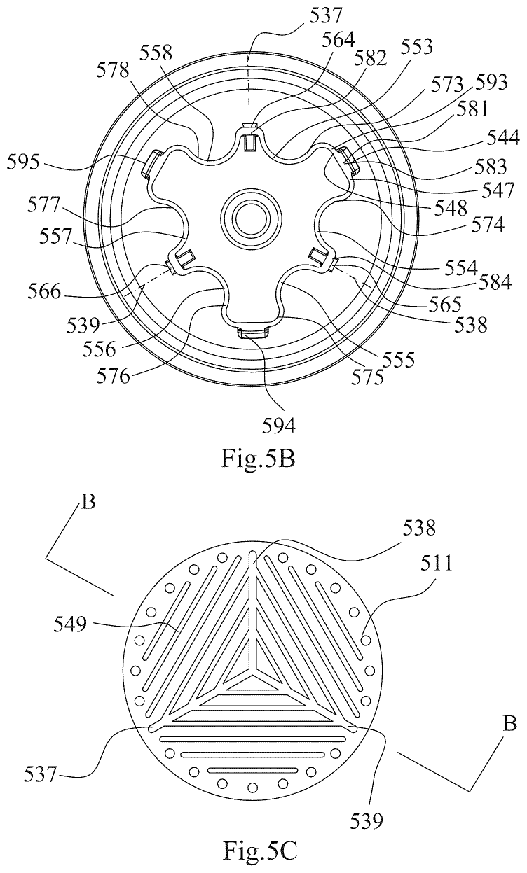

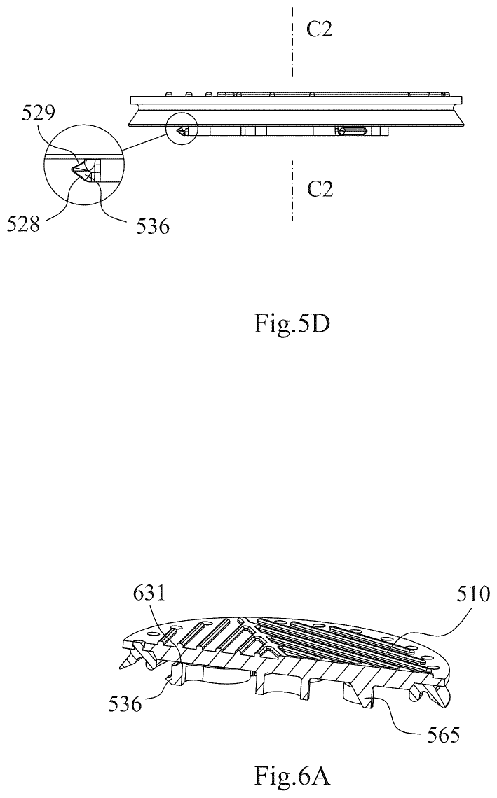

FIG. 5A is a perspective view of a plug according to a second embodiment of the present disclosure, FIG. 5B is a bottom view of the plug of FIG. 5A, FIG. 5C is a top view of the plug of FIG. 5A, and FIG. 5D is a side view of the plug of FIG. 5A.

The structure of the plug shown in FIG. 5A is similar to that of the plug shown in FIG. 1A, except for the configuration of the support portion 550. As shown in FIGS. 5A-5C, the plug 500 includes a cover body 510, a support portion 550, a connecting member 560, and a sealing portion 518, and has an axial direction and a radial direction. The cover body 510 is substantially the shape of a circular plate. The cover body 510 has a first side 511 and a second side 512 which are arranged opposite to each other in the axial direction. The first side 511 and the second side 512 extend in the radial direction. The support portion 550 is connected to the second side 512. The support portion 550 includes a first support block 564, a second support block 565, and a third support block 566. The first support block 564, the second support block 565, and the third support block 566 are connected to the second side 512 of the cover body 510 and are arranged in a circumferential direction. The support portion 550 has a center, and the distances from the center to the first support block 564, the second support block 565 and the third support block 566 are equal. The support portion 550 has a support portion central axis C2. The central axis C2 extends in the axial direction of the plug 500 and passes through the center of the support portion 550, that is, through the center of the circumference where the first support block 564, the second support block 565 and the third support block 566 are located. Each of the first support block 564, the second support block 565 and the third support block 566 extends from the second side 512 of the cover body 510 in a direction away from the cover body 510. Each of the first support block 564, the second support block 565 and the third support block 566 has a proximal end connected to the cover body 510, a distal end away from the cover body 510, and a side portion located between the proximal and distal ends. The side portion includes a pair of opposed side walls 568 and 569.

The sealing portion 518 is connected to the cover body 510 and extends in the thickness direction of the plug 500. The sealing portion 518 is close to a circumferential edge of the cover body 510. At least a portion of the sealing portion 518 is located on the second side 512 of the cover body 510. The sealing portion 518 is made of a hot melt adhesive, and the sealing portion 518 is connected to the cover body 510 by means of an overmolding process.

The connecting member 560 is connected to the support portion 550 and extends in a direction substantially parallel to the cover body 510. The dimension of the connecting member 560 in the radial direction is smaller than the dimension of the cover body 510 in the radial direction. The connecting member 560 is arranged separately from the cover body 510 and can be deformed in the direction substantially parallel to the cover body 510 to reduce the size of the outer contour of the connecting member 560. The connecting member 560 includes three engagement portions 544, 545 and 546 on an outer side thereof. The engagement portions 544, 545 and 546 can cooperate with the cover body 510 to connect the plug 500 to a corresponding portion.

The connecting member 560 has a plurality of engagement sections 593, 594 and 595, which are portions of the connecting member 560 that are further away from the support portion central axis C2. The engagement sections 593, 594 and 595 are substantially on the same circumference. The engagement portions 544, 545, 546 are arranged at the engagement sections 593, 594 and 595, respectively.

The engagement portions 544, 545 and 546 are arranged in the circumferential direction, and a first circumference where the engagement portions 544, 545 and 546 are located is larger in size than a second circumference where the first support block 564, the second support block 565 and the third support block 566 are located. In one embodiment of the present disclosure, both the centers of the first circumference and the second circumference are on the support portion central axis C2.

The connecting member 560 includes a first pair of retaining arms 573 and 574, a second pair of retaining arms 575 and 576, and a third pair of retaining arms 577 and 578. Each of the three pairs of retaining arms has the same structure and different positions. Each retaining arm has a first end connected to an adjacent retaining arm and a second end connected to the respective support block. For example, the first end 581 of the retaining arm 573 is connected to the first end 583 of the retaining arm 574, the second end 582 of the retaining arm 573 is connected to the support block 564, and the second end 584 of the retaining arm 574 is connected to the support block 565.

The middle of each of the retaining arms 573, 574, 575, 576, 577 and 578 is recessed toward the support portion 550, so as to form concave portions 553, 554, 555, 556, 557 and 558. The bottom of each of the concave portions 553, 554, 555, 556, 557 and 558 is closer to the support portion central axis C2 than the first support block 564, the second support block 565 and the third support block 566.

The first end of each connecting arm is provided with a bent section that is bent toward the direction of the support portion central axis C2. Adjacent bent sections are connected to each other to form an engagement section. For example, the retaining arm 573 has a bent section 548 at the first end 581 and the retaining arm 574 has a bent section 547 at the first end 583. The bent section 548 and the bent section 547 are connected to each other to form the engagement section 593. Each connecting arm is connected to the side walls 568 and 569 of the support block, respectively, and each concave portion is located between the respective engagement section and support block. When the engagement section is subjected to an external force toward the support portion central axis C2, the concave portion makes the retaining arm liable to deform, allowing the engagement section to move toward the support portion central axis C2.

The first side 511 of the cover body 510 has positioning marks 537, 538 and 539. The positioning marks 537, 538 and 539 are uniformly distributed in the circumferential direction and substantially aligned in the radial direction with the support blocks 564, 565 and 566. That is, the positioning marks 537, 538 and 539 are each located substantially between two adjacent engagement portions. The dashed lines in FIG. 5B illustrate the relative positions of the positioning marks 537, 538 and 539. It should be understood that the positioning marks are not visible on the second side 512 of the cover body 510. In one embodiment of the present disclosure, the positioning marks 537, 538 and 539 are ribs protruding from the surface of the first side 511. In other embodiments of the present disclosure, the positioning marks may be any recognizable marks, including stereoscopic shapes or patterns.

Between the positioning marks 537, 538 and 539 of the first side 511 of the cover body 510, there is further included a plurality of ribs 549 for increasing friction of the first side 511 of the cover body 510. The ribs 549 may be of other shapes that can increase friction.

Engagement portions 544, 545 and 546 are protrusions 534, 535 and 536 extending from the engagement sections 593, 594 and 595 of the connecting member 560 in a direction away from the support portion 550. Each of the protrusions 534, 535, and 536 is close to the end of the respective engagement section 593, 594 and 595 away from the cover body 510, and thus has a distance from the cover body 510. The protrusions 534, 535 and 536 extend outwardly in the radial direction and are gradually smaller in thickness. The protrusions 534, 535 and 536 are of the same structure, and the shape of the protrusion 536 will be described below as an example. Referring to FIG. 5D, the protrusion 536 includes a guide face 528 and an engagement face 529. The guide face is further away from the cover body 510 than the engagement face 529. The guide face 528 extends obliquely in the radial direction toward the cover body 510 for guiding the protrusion 536 into a hole of a mounting portion. The engagement face 529 is arranged to face the cover body 510, and the engagement face 529 extends horizontally in the radial direction, or extends slightly obliquely in a direction away from the cover body 510. The engagement face 529 cooperates with the cover body 510 and the sealing portion 518, allowing the mounting portion to be located between the cover body 510 and the engagement face 529. Two sides of the mounting portion are respectively contacted by the sealing portion 518 and the protrusion, and the plug 500 is not easily detached from the mounting portion.

When the protrusions 534, 535 and 536 of the connecting member 560 are subjected to external pressure, the connecting member 560 can be deformed such that the protrusions 534, 535 and 536 move toward the support portion central axis C2, and the size of the outer contour of the connecting member 560 is reduced and can enter into a hole in a corresponding portion.

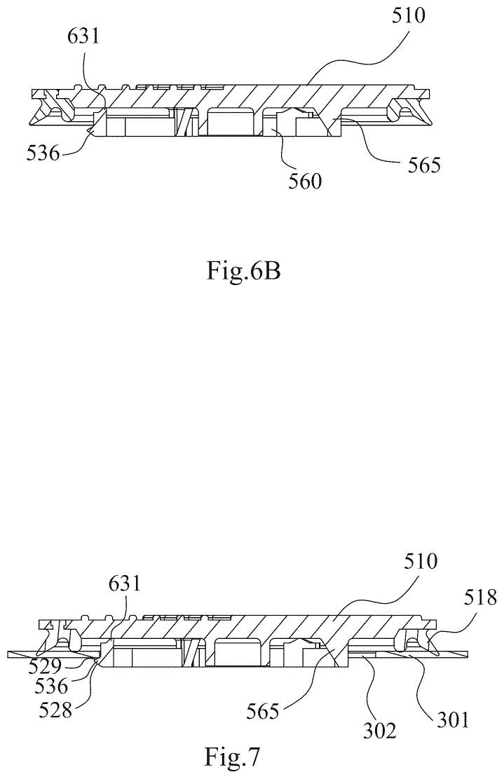

FIG. 6A is a cross-sectional view of the plug of FIG. 1D taken along a line B-B, and FIG. 6B is a cross-sectional perspective view of the plug of FIG. 6A.

As shown in FIGS. 6A and 6B, the connecting member 560 is arranged separately from the cover body 510, with a gap between the connecting arms of the connecting member 560 and the cover body 510. The connecting member 560 comprises an abutting portion 631. The abutting portion 631 is connected to the engagement section 595 and can abut against the second side 512 of the cover body 510. The abutting portion 631 prevents the connecting member 560 from moving toward the cover body 510 in the axial direction or reduces the distance by which the connecting member 560 moves toward the cover body 510 during entry of the connecting member 560 into the hole in the mounting portion.

In other embodiments of the present disclosure, the abutting portion is arranged at other positions on the connecting member 560. In another embodiment of the present disclosure, the connecting member 560 is in contact with the cover body 510, and it is not necessary to provide any additional abutting portion 631.

In the thickness direction of the plug, the connecting member 560 overlaps with at least a portion of the support portion 550. In one embodiment of the present disclosure, in the thickness direction of the plug, the connecting member 560 does not extend beyond the end of the support portion 550 away from the cover body 510.

The cross-sectional shape of the support block 565 is substantially triangular, with a width that gradually decreases in the radial direction from the proximal end to the distal end. The support block 565 has a certain thickness in the circumferential direction.

The mounting process of the plug in this embodiment is the same as that of the embodiment shown in FIGS. 1A-3B and will not be repeated here.

FIG. 7 is a cross-sectional view of the plug of FIG. 5A mounted in the mounting portion in place.

As shown in FIG. 7, when the plug 500 is mounted in the mounting portion 301 in place, the mounting portion is clamped between the sealing portion 518 of the cover body 510 and the protrusions 534, 535 and 536, and the plug 500 is connected to the mounting portion 301. The sealing portion 518 abuts against the first surface of the mounting portion 301. In this case, the plug 100 is not easily movable relative to the mounting portion 301. The sealing portion 518 is heated by using a hot melt tool. After the hot melting and condensation process, the sealing portion 518 forms a seal with the first surface 311, thereby sealing and closing the hole 302 in the mounting portion 301.

The plug in this embodiment can achieve a similar technical effect as the embodiment shown in FIG. 1A. The connecting member 560 of the plug 500 can be deformed in a direction parallel to the cover body, and the connecting member 560 has good elasticity and is easy to be mounted to the mounting portion 301. Moreover, the connecting member 560 may be set shorter in the axial direction. That is, the thickness of the connecting member 560 is relatively small, so that the overall thickness of the plug 500 is relatively small. In one embodiment of the present disclosure, the distance from the side of the connecting member 560 away from the cover body 510 to the second side of the cover body 510 is no more than 2 times the thickness of the cover body 510. In one embodiment of the present disclosure, the distance from the side of the connecting member 560 away from the cover body 510 to the second side of the cover body 510 is no more than 1.8 times the thickness of the cover body 510.

Compared with the embodiment shown in FIG. 1A, the connecting member 560 in this embodiment has a simpler structure and is easier to manufacture.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A plug for covering a hole in a component, the plug comprising:
a cover body having a thickness direction;
a support portion connected to a side of the cover body in the thickness direction and having a support portion central axis; and
a connecting member connected to the support portion and comprising at least two engagement portions arranged around the support portion central axis,
wherein the connecting member has elasticity to enable the at least two engagement portions to move toward the support portion central axis with elastic deformation of the connecting member.

2. The plug of claim 1, wherein the at least two engagement portions comprise at least two protrusions and the protrusions are connected to an end of the connecting member away from the cover body and extend in a direction away from the support portion central axis, the protrusions having a distance from the cover body.

3. The plug of claim 1, wherein the connecting member extends in a direction substantially parallel to the cover body and has a distance from a circumferential edge of the cover body.

4. The plug of claim 1, wherein a maximum distance from the engagement portions of the connecting member to the support portion central axis is greater than a maximum distance from an outer side of the support portion to the support portion central axis.

5. The plug of claim 1, wherein the connecting member has at least two connecting arms, the at least two connecting arms connecting the engagement portions to the support portion.

6. The plug of claim 5,
wherein the support portion comprises a support block, and the at least two connecting arms comprise at least two first connecting arms and at least two second connecting arms, and
wherein the at least two first connecting arms are connected in sequence, each of the engagement portions is arranged at a joint of adjacent first connecting arms, and the second connecting arms connect corresponding first connecting arms to the support block.

7. The plug of claim 6, wherein each of the first connecting arms comprises a concave portion recessed toward the support block, the concave portion being located in the middle of the corresponding first connecting arm.

8. The plug of claim 6, wherein a connection line connecting two ends of each of the second connecting arms is staggered from a central axis of the support block.

9. The plug of claim 7, wherein a joint of the second connecting arm and the first connecting arm and a joint of the second connecting arm and the support block are respectively close to two adjacent concave portions in a circumferential direction, and the second connecting arm is bent toward the corresponding engagement portion.

10. The plug of claim 5,
wherein the support portion comprises at least two support blocks, and the at least two connecting arms comprise at least two pairs of connecting arms, and
wherein respective first ends of each of the pairs of connecting arms are connected to each other, respective second ends of each of the pairs of connecting arms are connected to the corresponding support blocks, and the engagement portion is arranged at a joint of the first ends of one of the pairs of connecting arms.

11. The plug of claim 5, wherein each of the at least two pairs of connecting arms comprises a concave portion recessed toward the support portion central axis.

12. The plug of claim 11, wherein a minimum distance from the concave portion to the central axis is less than a distance from the support block to the support portion central axis.

13. The plug of claim 5,
wherein the connecting member is arranged separately from the cover body, and
wherein the connecting member comprises an abutting portion, the abutting portion abutting against a surface of a second side of the cover body and being slidable relative to the cover body when subjected to a force in a direction toward or away from the support block.

14. The plug of claim 13, wherein the abutting portion is arranged close to the engagement portions.

15. The plug of claim 1, wherein positioning marks are provided on a side of the cover body away from the support block in the thickness direction, and each of the positioning marks is located between the adjacent engagement portions in a circumferential direction.

16. The plug of claim 5, wherein a distance from a side of the connecting member away from the cover body to a second side of the cover body is not more than twice the thickness of the cover body.

17. The plug of claim 1, wherein the plug further comprises a sealing portion connected to the cover body and close to a circumferential edge of the cover body, and at least a portion of the sealing portion is located at a side of the cover body connected to the support block, the sealing portion comprising a hot melt adhesive.

18. The plug of claim 1, wherein the support portion has a side portion, the connecting member is connected to the side portion of the support portion, and the connecting member overlaps at least a portion of the support portion in the thickness direction of the cover body.
